(19) United States
(12) Patent Application Publication
(10) Pub. No.: US 2005/0226789 A1
(43) Pub. Date: Oct. 13, 2005

(54) Reactor system for carrying out chemical reactions in parallel, in particular polymerisation reactions

(76) Inventors: Sebastian Koltzenburg, Dannstadt-Schauernheim (DE); Stefan Bentz, Ludwigshafen (DE); Axel Fiebranz, Friedelsheim (DE); Harald Rodel, Mutterstadt (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/517,007

(22) PCT Filed: Jun. 11, 2003
(86) PCT No.: PCT/EP03/06101

§ 371 Date: Dec. 6, 2004

(30) Foreign Application Priority Data
Jun. 11, 2002 (DE) 10225930.5

(51) Int. Cl. B01J 19/00

(52) U.S. Cl. 422/130

(57) ABSTRACT

An automated synthesis apparatus for carrying out chemical reactions with reflux cooling including one or more reactor modules each having one reactor, one or more feed vessels each for a liquid reactant or reactant mixture, and one or more metering and feed devices for introduction of liquid reactant or reactant mixture from the one or more feed vessels into the one or more reactors. Each reactor has a lid configured as a hollow body to enclose a hollow space, with an inlet line and an outlet line for a heat transfer medium into or out of the hollow space and with one or more through-lines for introduction of each liquid reactant or reactant mixture into the reactor.

The invention relates to an automated synthesis apparatus comprising one or more reactor modules.

The growing need for synthetic products which meet increased quality requirements has led to the development of automated synthesis apparatuses in which chemical syntheses are carried out under the control of a program without manual intervention.

Use is frequently made of automated synthesis apparatuses having a plurality of reactor modules so that parallel reactions can proceed in the reactor modules.

Chemical reactions are frequently carried out with reflux cooling. A problem which occurs is that in the case of small reactors as are typical for automated synthesis apparatuses it is difficult to integrate the reflux condenser and the coolant lines in the space available.

It is an object of the present invention to provide an automated synthesis apparatus which does not have the disadvantages mentioned.

We have found that this object is achieved by an automated synthesis apparatus for carrying out chemical reactions with reflux cooling comprising one or more reactor modules each having one reactor, one or more feed vessels each for a liquid reactant or reactant mixture and also one or more metering and feed devices for the introduction of liquid reactant or reactant mixture from the feed vessel (the feed vessels) into the reactor, wherein each reactor has a lid which is configured as a hollow body and encloses a hollow space, with an inlet line and an outlet line for a heat transfer medium into or out of the hollow space and with one or more through-lines for introduction of each liquid reactant or reactant mixture into the reactor.

In this construction, the reflux condenser is integrated into the reactor lid so as to provide a miniaturized system which can be operated in a simple manner by means of a robot arm. In particular, the reflux condenser which is now configured as a lid can easily be removed and installed, for example for cleaning purposes.

The lid cooling reduces the formation of deposits, also known as fouling, on the lid, thus reducing the need for cleaning.

The invention is not restricted in respect of the volume, the geometry or the materials of construction of the reactors. However, preference is given to automated synthesis apparatuses having reactors whose volume is in the range from 1 ml to 100 ml, in particular in the range from 10 to 50 ml. As regards the reactor geometry, use is frequently made of cylindrical reactors, but, for example, cuboidal reactors can also be used.

In a preferred variant, the lid is flat and is in particular configured as a flat disk. This geometric configuration is advantageous in respect of ease of manufacture, assembly, sealing and cleaning.

To improve heat removal, good flow of the heat transfer medium through the hollow space of the lid is desirable. For this purpose, the inlet line for the heat transfer medium is preferably configured so that it projects into the hollow space of the lid and/or the outlet line for the heat transfer medium is configured so that it ends flush with the interior wall enclosing the hollow space of the lid.

In a preferred variant, the through-lines for the liquid reactant(s) or reactant mixture(s) are configured so that they project beyond the lower edge of the lid into the interior space of the reactor. This achieves uniform reflux since the condensate drips off at the ends of the through-lines projecting beyond the lower edge of the lid into the interior space of the reactor and does not become distributed over the underside of the lid.

In a further preferred embodiment, the lid has an increased cross section at its underside and at its upper side. This aids operation by means of a robot arm.

The invention is illustrated below with the aid of drawings.

In the drawings:

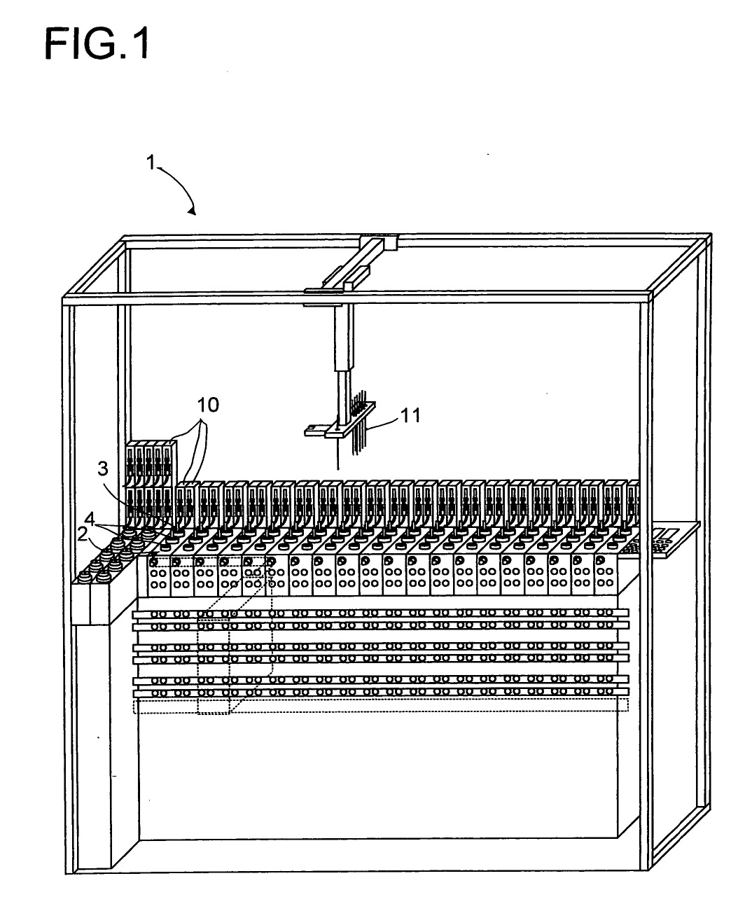

FIG. 1 schematically shows an automated synthesis apparatus 1 with, by way of example, 20 reactor modules 2 and

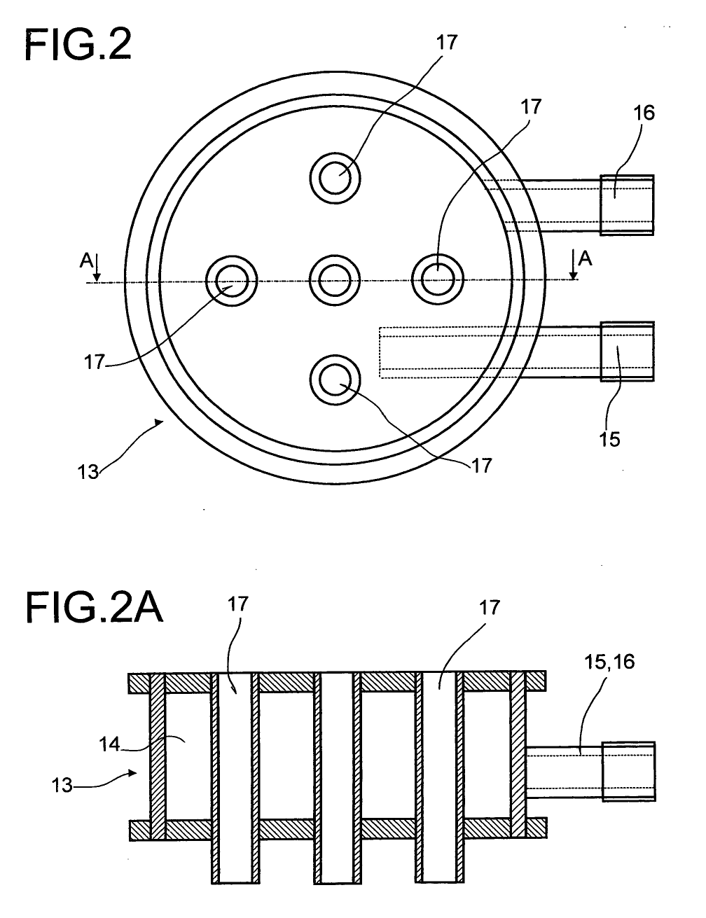

FIG. 2 schematically shows a lid 13 for a reactor 3 with the section A/A depicted in FIG. 2A.

The automated synthesis apparatus 1 shown schematically in FIG. 1 is equipped with, by way of example, 20 reactor modules 2 which can each be moved as a whole. Each reactor module 2 has two feed vessels 4 and a reactor 3. A metering and transport device 5 is provided for each feed vessel 4; FIG. 1 shows only the pumps 10 and the metering fingers 11 which can be moved by means of a robot arm for these metering and feed devices 5. The feed line between pump 10, metering finger 11 and feed vessels 4 or reactor 3 is not shown.

FIG. 2 schematically shows an embodiment of a lid 13 with integrated reflux condenser for a reactor. In the cross-sectional depiction in FIG. 2, four through-lines 17 each for one liquid reactant or reactant mixture are shown leading into the reactor. The opening shown as a central double circle, which bears no reference numeral, is intended for accommodation of a stirrer.

It can be seen from FIG. 2 that, in the particular embodiment shown, the inlet line 15 for the heat transfer medium into the hollow space of the lid 13 projects into the latter and that the outlet line 16 for the heat transfer medium ends flush with the interior wall surrounding the hollow space of the lid 13.

The section A/A depicted in FIG. 2a makes clear the shape of the lid 13 as a hollow body which encloses a hollow space 14. FIG. 2a also shows the through-lines 17 which are extended beyond the lower edge of the lid and also inlet line 15 and outlet line 16 for the heat exchange medium. It can also be seen from FIG. 2a that the lid has an increased cross section at its underside and at its upper side.

1-5. (canceled)

6. An automated synthesis apparatus for carrying out chemical reactions with reflux cooling comprising:
one or more reactor modules each having one reactor;
one or more feed vessels each for a liquid reactant or reactant mixture; and
one or more metering and feed devices for introduction of liquid reactant or reactant mixture from the one or more feed vessel into the one or more reactors,
wherein each reactor includes a lid configured as a hollow body to enclose a hollow space, with an inlet line and an outlet line for a heat transfer medium into or out of the hollow space and with one or more through-lines for introduction of each liquid reactant mixture into the reactor.

7. An automated synthesis apparatus as claimed in claim 6, wherein the lid is flat.

8. An automated synthesis apparatus as claimed in claim 7, wherein the lid is configured as a flat disk.

9. An automated synthesis apparatus as claimed in claim 6, wherein the inlet line for the heat transfer medium projects into the hollow space of the lid and/or the outlet line for the heat transfer medium ends flush with an interior wall of the lid enclosing the hollow space.

10. An automated synthesis apparatus as claimed in claim 6, wherein the one or more through-lines project beyond a lower edge of the lid into the interior space of the reactor.

11. An automated synthesis apparatus as claimed in claim 6, wherein the lid has an increased cross section at its underside and at its upper side.
